(19) United States
(12) Patent Application Publication
(10) Pub. No.: US 2012/0228547 A1
(43) Pub. Date: Sep. 13, 2012

(54) MOISTURE CONTROL CONSTRUCTION MATERIAL AND METHOD FOR PRODUCING THE SAME

(75) Inventors: Shuji Kawai, Tokyo (JP); Michihiro Takeda, Tokyo (JP); Yoshiaki Hirasawa, Tokyo (JP)

(73) Assignee: LIXIL CORPORATION, Tokyo (JP)

(21) Appl. No.: 13/365,870

(22) Filed: Feb. 3, 2012

(30) Foreign Application Priority Data
Mar. 9, 2011 (JP) 2011-051521

(51) Int. Cl. C09K 3/00; C04B 33/13

(52) U.S. Cl. 252/194; 264/679

(57) ABSTRACT

Provide is a moisture control constructional material which has improved moisture control performance and strength and which is easily produced, and a method for producing the same. The moisture control construction material is produced by forming a raw material that contains aluminum hydroxide and talc, and firing the formed raw material at 700° C. to 1100° C. The raw material contains 20% to 95% by weight aluminum hydroxide and 5% to 80% by weight of the talc-like material. The raw material may further contain at least one of clay and bentonite and/or montmorillonite.

### TECHNICAL FIELD

The present invention relates to a moisture control construction material made from aluminum hydroxide serving as a raw material and a method for producing the same, and more particularly, to a moisture control construction material to which processability is imparted while the moisture control properties of a fired article of aluminum hydroxide are maintained, and to a method for producing the same.

### BACKGROUND ART

Dehydrated aluminum hydroxide produced by heat treatment of an aluminum hydroxide powder has moisture absorbing and desorbing properties. Thus, a moisture control construction material produced by adding additives to aluminum hydroxide, subjecting the mixture to mixing, forming, and firing is reported.

Patent Literature 1 (Japanese Patent Publication 2001-122657) describes a moisture control construction material produced as follows: Aluminum hydroxide and clay are mixed in such a manner that the resulting mixture has a chemical composition of 33% to 76% by weight of Al₂O₃, 15% to 57% by weight of SiO₂, 5% by weight or less of the total amount of Na₂O, K₂O, Li₂O, B₂O₃, and 9% by weight or less of the total amount of P₂O₅, CaO, BaO, and MgO. The mixture is mixed and formed. Then the formed article is fired in such a manner that the main peak of k-Al₂O₃ is detected in an X-ray diffraction chart and that the height of the main peak of k-Al₂O₃ is greater than that of α-Al₂O₃.

In Patent Literature 1, the moisture absorbing and desorbing properties of alumina (aluminum oxide) produced by the dehydration of aluminum hydroxide is utilized, and the sintering-enhancing effect of the clay used together with the raw material aluminum hydroxide allows a fired article (sintered body) to have high strength.

Patent Literature 2 (Japanese Patent Publication 2002-249372) describes that materials containing aluminum hydroxide, a kaolin powder, and water glass are mixed, formed, and fired to produce a moisture control construction material.

In Patent Literature 2, the incorporation of the water glass into the materials allows the moisture control construction material to have enhanced strength.

### CITATION LIST

[PTL 1] Japanese Patent Publication 2001-122657

[PTL 2] Japanese Patent Publication 2002-249372

The dehydration of aluminum hydroxide by firing brings about a porous state in which a large number of pores are present. The pores provide excellent moisture control performance. Such an aluminum hydroxide-based moisture control construction material is porous and thus is brittle. For example, in the case where the moisture control construction material is used for wall surfaces, the minute cracking and motion of a framework produce cracks. It is thus necessary to increase the strength without considerably reducing the moisture control performance.

In Patent Literature 1, the incorporation of the clay into the materials results in the tight binding of dehydrated aluminum hydroxide to increase the strength while the collapse of micropores in the dehydrated aluminum hydroxide due to sintering is inhibited. In Patent Literature 2, the water glass melts at a low temperature and solidifies dehydrated aluminum hydroxide to increase the strength.

However, higher proportions of clay and water glass in the materials result in a relative reduction in the amount of aluminum hydroxide in the materials, thereby reducing moisture control performance. Furthermore, in the case where the strength is increased by simply increasing the amounts of clay and water glass added, the processability, in particular, cutting properties, of a moisture control construction material is reduced.

In the case where water glass is incorporated, water glass melts at the time of firing and clogs pores that control moisture, thereby reducing the moisture control performance. Furthermore, in the case where water glass is used, a powder to be compacted is sticky; hence, the powder adheres to a mold at the time of compacting, reducing productivity.

### OBJECT OF INVENTION

It is an object of the present invention to provide a moisture control construction material which has excellent processability and is easily produced, compared with the moisture control construction materials described in Patent Literatures 1 and 2, and a method for producing the moisture control construction material.

### SUMMARY OF INVENTION

A moisture control construction material according to aspect 1 is produced by forming a raw material that contains aluminum hydroxide, a talc-like material, clay, and bentonite and/or montmorillonite, and firing the formed raw material.

According to aspect 2, in the moisture control construction material according to aspect 1, the raw material contains 20% to 80% by weight aluminum hydroxide, 5% to 70% by weight of the talc-like material, 5% to 74% by weight clay, and 1% to 30% by weight bentonite and/or montmorillonite.

A moisture control construction material according to aspect 3 is produced by forming a raw material that contains aluminum hydroxide and a talc-like material, and firing the formed raw material.

According to aspect 4, in the moisture control construction material according to aspect 3, the raw material contains 20% to 95% by weight aluminum hydroxide and 5% to 80% by weight of the talc-like material.

According to aspect 5, in the moisture control construction material according to aspect 3, the raw material contains 20% to 90% by weight aluminum hydroxide, 5% to 70% by weight of the talc-like material, and 5% to 75% by weight clay.

According to aspect 6, in the moisture control construction material according to aspect 3, the raw material contains 20% to 90% by weight aluminum hydroxide, 5% to 70% by weight of the talc-like material, and 3% to 30% by weight bentonite and/or montmorillonite.

According to aspect 7, in the moisture control construction material according to any one of aspects 1 to 6, the talc-like material is at least one of talc, a serpentine subgroup, and a chlorite group.

A method for producing a moisture control construction material according to aspect 8 includes forming a raw material that contains aluminum hydroxide, a talc-like material, clay, and bentonite and/or montmorillonite, and firing the formed raw material at 700° C. to 1100° C.

According to aspect 9, in the method for producing a moisture control construction material according to aspect 8, the raw material contains 20% to 80% by weight aluminum hydroxide, 5% to 70% by weight of the talc-like material, 5% to 74% by weight clay, and 1% to 30% by weight bentonite and/or montmorillonite.

A method for producing a moisture control construction material according to aspect 10 includes forming a raw material that contains aluminum hydroxide and a talc-like material, and firing the formed raw material at 700° C. to 1100° C.

According to aspect 11, in the method for producing a moisture control construction material according to aspect 10, the raw material contains 20% to 95% by weight aluminum hydroxide and 5% to 80% by weight of the talc-like material.

According to aspect 12, in the method for producing a moisture control construction material according to aspect 10, the raw material contains 20% to 90% by weight aluminum hydroxide, 5% to 70% by weight of the talc-like material, and 5% to 75% by weight clay.

According to aspect 13, in the method for producing a moisture control construction material according to aspect 10, the raw material contains 20% to 90% by weight aluminum hydroxide, 5% to 70% by weight of the talc-like material, and 3% to 30% by weight bentonite and/or montmorillonite.

According to aspect 14, in the method for producing moisture control construction material according to any one of aspects 10 to 13, the talc-like material is at least one of talc, a serpentine subgroup, and a chlorite group.

According to aspect 15, in the method for producing a moisture control construction material according to any one of aspects 10 to 14, at least part of the raw material is calcined.

### ADVANTAGEOUS EFFECTS OF INVENTION

Aluminum hydroxide is dehydrated by firing at about 300° C. to 500° C. to become porous, thereby providing moisture control properties. However, the porous aluminum hydroxide does not have strength sufficient for construction materials. In the case where aluminum hydroxide is sintered at a high temperature in order to increase the strength, the moisture control properties disappear. In the present invention, aluminum hydroxide is mixed with a talc-like material. The talc-like material is formed of plate-shape or foliated particles and thus prevents the fixing of dehydrated aluminum hydroxide formed by firing at 300° C. to 500° C., which is a relatively low temperature, and prevents the disappearance of the moisture control properties of the dehydrated aluminum hydroxide. Furthermore, the particles of the talc-like material are entangled with the dehydrated aluminum hydroxide, thereby imparting strength sufficient for construction materials thereto. The talc-like material has a high melting point and thus will not cause the dehydrated aluminum hydroxide to fuse. Moreover, the particles of the talc-like material are soft and thus improve the processability of the moisture control construction material.

In the case where a raw material containing aluminum hydroxide and talc is fired at 700° C. to 1100° C., talc begins to release SiO₂ at about 700° C. The released SiO₂ acts on the porous phase of dehydrated aluminum hydroxide; hence, the porous state of the dehydrated aluminum hydroxide is more likely to be maintained. This improves the moisture control properties. Furthermore, both the softness of the porous dehydrated aluminum hydroxide and the softness of talc improves the processability of the moisture control construction material. However, if the firing temperature exceeds 1100° C., it is difficult to maintain the porous dehydrated aluminum hydroxide.

Further incorporation of clay into aluminum hydroxide and talc improves the strength owing to the fixing effect of the clay while the moisture control properties of dehydrated aluminum hydroxide are ensured.

In the present invention, in the case where clay is further added to the raw material, the clay begins to release SiO₂ at about 800° C. in addition to the effect due to the release of SiO₂ from talc at about 700° C. or higher; hence, the porous state of the dehydrated aluminum hydroxide is maintained in a wider temperature range, thereby improving the moisture control performance. Furthermore, the fixing effect of the clay improves the strength of the moisture control construction material. Moreover, clay has a high degree of refractoriness; hence, even if a moisture control construction material is fired at 800° C. or higher, the moisture control performance is maintained. This indicates that various pigments and glazes may be used to improve the decorativeness of the moisture control construction material.

In the case where bentonite and/or montmorillonite is added to a raw material, dehydrated aluminum hydroxide is tightly fixed because bentonite and/or montmorillonite has higher fixing strength than clay, thereby enabling the moisture control construction material to have high strength.

Furthermore, bentonite and/or montmorillonite is a layer mineral in which H₂O intervenes between layers. Bentonite and/or montmorillonite is fired to release a large amount of interlayer water at about 600° C., thereby providing a collapsed structure. The entanglement of dehydrated aluminum hydroxide with the dehydrated bentonite and/or montmorillonite having the structure facilitates the maintenance of the porous state of the dehydrated aluminum hydroxide. In addition, bentonite and/or montmorillonite is not melted by firing at about 700° C. to 1100° C. and thus does not clog micropores of the dehydrated aluminum hydroxide, thus leading to high moisture control performance of the moisture control construction material.

In the present invention, as described above, the presence of the talc-like material, clay, and bentonite and/or montmorillonite inhibits the α-alumina crystallization reaction of the dehydrated aluminum hydroxide. Most of the dehydrated material (aluminum oxide) remains porous. Furthermore, proportions of glass-forming components, such as Na₂O, K₂O, Li₂O, B₂O₃, P₂O₅, and BaO, are low; hence, clogging of the pores by the formation of a glass melt is inhibited.

Moreover, the incorporation of the talc-like material, clay, and bentonite and/or montmorillonite into the raw material improves formability and formativeness at the time of forming.

### DESCRIPTION OF EMBODIMENTS

To produce a moisture control construction material of the present invention, aluminum hydroxide, a talc-like material, if necessary, clay, and bentonite and/or montmorillonite are mixed together, formed, and fired.

As aluminum hydroxide, powdery aluminum hydroxide is preferred. Aluminum hydroxide may have any form, for example, gibbsite, bayerite, boehmite, diaspore, alumina sol, or alumina gel. Note that various aluminum compounds, such as aluminum chloride and aluminum nitride, which become porous by firing, may also be used. However, the hydroxide is most preferred.

As the talc-like material, the serpentine subgroup (chrysotile, antigorite, and lizardite) and the chlorite group (clinochlore, chamosite, sudoite, and cookeite) may be used in addition to talc. However, talc is preferred.

Bentonite is a mineral that is mainly composed of montmorillonite and is often accompanied with quartz, cristobalite, feldspars, carbonate minerals, and so forth. Typical examples thereof include Na bentonite and Ca bentonite containing Na montmorillonite and Ca montmorillonite; acid clay formed when bentonite is weathered; and activated clay formed by the treatment of the acid clay.

As the clay, various clays containing kaolin minerals, such as kibushi clay, gairome clay, fire clay, stoneware clay, and kaolin, may be used.

Compounding ratios of these materials are preferably set as described below.

For Aluminum Hydroxide-Talc-Like Material Two-Component System
Aluminum hydroxide: 20% to 95% by weight and particularly 25% to 60% by weight
Talc-like material: 5% to 80% by weight and particularly 10% to 55% by weight

For Aluminum Hydroxide-Talc-Like Material-Clay Three-Component System
Aluminum hydroxide: 20% to 90% by weight and particularly 25% to 60% by weight
Talc-like material: 5% to 70% by weight and particularly 10% to 55% by weight
Clay: 5% to 75% by weight and particularly 5% to 60% by weight

For Aluminum Hydroxide-Talc-Like Material-Bentonite and/or Montmorillonite Three-Component (or Four-Component) System
Aluminum hydroxide: 20% to 90% by weight and particularly 25% to 60% by weight
Talc-like material: 5% to 70% by weight and particularly 10% to 55% by weight
Bentonite and/or montmorillonite: 3% to 30% by weight and particularly 5% to 20% by weight

For Aluminum Hydroxide-Talc-Like Material-Clay-Bentonite and/or Montmorillonite Four-Component (or Five-Component) System
Aluminum hydroxide: 20% to 80% by weight and particularly 25% to 60% by weight
Talc-like material: 5% to 70% by weight and particularly 10% to 55% by weight
Clay: 5% to 74% by weight and particularly 10% to 55% by weight
Bentonite and/or montmorillonite: 1% to 30% by weight and particularly 5% to 20% by weight

In the present invention, the raw material most preferably contains aluminum hydroxide, a talc-like material, clay, and bentonite and/or montmorillonite. In this case, the composition of the moisture control construction material after firing preferably falls within the range described below.

Al₂O₃: 10% to 95% by weight and particularly 20% to 60% by weight

SiO₂: 3% to 65% by weight and particularly 15% to 55% by weight

The total of CaO and MgO: 2% to 35% by weight or less and particularly 5% to 30% by weight or less

Flux (the total of Na₂O, K₂O, Li₂O, B₂O₃, P₂O₅, and BaO): 5% by weight or less and particularly 3% by weight or less

A SiO₂ content exceeding 65% by weight results in the degradation of the sinterability of the raw material and results in an excessively low Al₂O₃ content to degrade the moisture control properties. A SiO₂ content of less than 3% by weight results in a reduction in the strength of a sintered body. In this case, an excessively small amount of the talc-like material, bentonite and/or montmorillonite, or clay leads to a reduction in formability.

A total amount of CaO and MgO exceeding 35% by weight results in clogging of micropores in the moisture control construction material are clogged to reduce the moisture control properties. A flux content exceeding 5% by weight results in clogging of micropores of the moisture control construction material, thereby reducing the moisture control properties.

In the present invention, sintering-aid components, such as various glass powders and frits, sheet glasses for buildings and automobiles, and various slags, e.g., municipal-waste molten slag and steelmaking slag, may be incorporated as long as the moisture control properties and strength of the moisture control construction material are not adversely affected. The sintering-aid component content is preferably 50 parts by weight or less and particularly 30 parts by weight or less with respect to 100 parts by weight of aluminum hydroxide, the talc-like material, bentonite and/or montmorillonite, and clay.

At least some of the materials, for example, at least one of aluminum hydroxide, the talc-like material, bentonite and/or montmorillonite, and clay, may be calcined at a temperature (e.g., about 500° C. to 800° C.) lower than a firing temperature of 700° C. to 1100° C. Calcination of the materials increases the activity of the materials, thus improving the firing properties. Furthermore, in the case where materials, such as aluminum hydroxide and clay, which will be dehydrated at the time of firing, and a material that will be decarboxylated at the time of firing are calcined, rapid dehydration and decarboxylation at the time of firing are prevented. This prevents, for example, the cracking of the resulting fired article.

After the foregoing materials are optionally pulverized, the materials are mixed together and formed. A pulverization method, a mixing method, and a forming method are not particularly limited. Examples of the forming method include press forming and extrusion forming. A forming aid, such as methyl cellulose, may be added to the material. A moisture control construction material may be formed to have an appropriate shape, such as a plate shape, a block shape, or a tubular shape.

The formed material is optionally dried and then fired at preferably 700° C. to 1100° C. and particularly 750° C. to 1100° C. for 0.2 to 100 hours and preferably 0.3 to 72 hours.

This provides a moisture control construction material having a bending strength of 2.5 MPa or more, in which when the moisture control construction material having a constant weight in an atmosphere having a relative humidity of 50% at 25° C. is brought into contact with air having a relative humidity of 90% at 25° C. for 24 hours, the amount of moisture absorbed is 150 g/m² or more.

In the present invention, values of the bending strength, the amount of moisture absorbed and so forth are determined by methods described below.

Bending strength: The bending strength is determined by a three-point bending method.

Moisture control performance: After a moisture control construction material whose back face and end faces are sealed with an aluminum tape is placed in a thermo-hygrostat having a relative humidity of 50% at 25° C. until the weight of the moisture control construction material is not changed (until variations in weight is 0.1% or less), the moisture control construction material is placed in a thermo-hygrostat having a relative humidity of 90% at 25° C. After 24 hours, an increase in weight and dimensions of a specimen are measured. The amount of moisture absorbed in terms of a unit area (1 m²) is defined as an index.

In the present invention, a surface of a moisture control construction material may be subjected to application of a light coating of a glaze to enhance design quality and stain resistance. In this case, in order not to impair the moisture control properties, the application is preferably performed in such a manner that a glass layer made from the glaze is formed in a region having an area 90% or less of the surface area of the main body of the moisture control construction material or the glass layer has a maximum thickness of 300 μm or less.

### EXAMPLES

### Example 1

After 55 parts by weight of industrial aluminum hydroxide (Al(OH)₃, grade: 99.6% purity) and 45 parts by weight of talc (from Liaoning, China) were pulverized and mixed in a ball mill, the mixture was subjected to press forming to form a 110×110×5.5 mm formed article. The formed article was fired at 800° C. for 1.0 hour, thereby producing a moisture control construction material.

Table 1 shows the measurement results of the amount of moisture absorbed, the bending strength, and the processability of the moisture control construction material.

Note that the processability indicates a cut length for 30 seconds when a man cuts the moisture control construction material with a wood saw at a normal working speed.

### Examples 2 to 14 and Comparative Examples 1 to 3

Moisture control construction materials were produced as in Example 1, except that the compounding ratios of the materials and firing temperatures were set as described in Table 1 and that in Example 14, aluminum hydroxide, talc, and clay were calcined at 500° C. and then pulverized and mixed with other materials. The same measurements were performed. Table 1 shows the results. In Comparative Examples 1 and 2, the fired articles were not handled. Thus, the processability and the bending strength were not measured. Clay produced from Seto, Aichi-ken was used. Bentonite produced from Annaka, Gunma-ken was used. In each of Examples 1 and 2, 7.5 parts by weight of polyvinyl alcohol was incorporated as a molding binder. In Example 14, the expression “50+4” of aluminum hydroxide indicates 50 parts by weight of aluminum hydroxide and 4 parts by weight of aluminum hydroxide calcined at 500° C. The expression “15+6” of talc indicates 15 parts by weight of talc and 6 parts by weight of talc calcined at 500° C. The expression “7.5+5” of clay indicates 7.5 parts by weight of clay and 5 parts by weight of clay calcined at 500° C.

TABLE 1

| | | | | | | Amount of | | |
|---|---|---|---|---|---|---|---|---|
| | Raw material (parts by weight) | | | | Firing | moisture | Bending | |
| | Aluminum | | | | temperature | absorbed | strength | Processability |
| No. | hydroxide | Talc | Clay | Bentonite | (° C.) | (g/m²) | (MPa) | (mm/30 seconds) |
| Comparative | 100 | | | | 1000 | 300 | unmeasurable | — |
| Example 1 | | | | | | | because of its | |
| | | | | | | | high fragility | |
| Comparative | 100 | | | | 1100 | 170 | unmeasurable | — |
| Example 2 | | | | | | | because of its | |
| | | | | | | | high fragility | |
| Comparative | 55 | | 45 | | 800 | 657 | 2.3 | 100 |
| Example 3 | | | | | | | | |
| Example 1 | 55 | 45 | | | 800 | 600 | 3.0 | 950 |
| Example 2 | 55 | 45 | | | 850 | 520 | 3.3 | 800 |
| Example 3 | 55 | 30 | 15 | | 800 | 605 | 2.7 | 847 |
| Example 4 | 40 | 45 | 15 | | 800 | 469 | 3.0 | 731 |
| Example 5 | 55 | 15 | 30 | | 800 | 660 | 2.7 | 346 |
| Example 6 | 55 | 15 | 30 | | 850 | 611 | 4.3 | 200 |
| Example 7 | 55 | 30 | | 15 | 800 | 529 | 5.3 | 276 |
| Example 8 | 55 | 15 | 15 | 15 | 800 | 559 | 6.2 | 266 |
| Example 9 | 55 | 30 | 7.5 | 7.5 | 800 | 633 | 4.9 | 386 |
| Example 10 | 25 | 57 | 15 | 3 | 800 | 278 | 6.6 | 320 |
| Example 11 | 25 | 47 | 25 | 3 | 800 | 280 | 7.5 | 233 |
| Example 12 | 55 | 30 | 7.5 | 7.5 | 800 | 596 | 2.9 | 231 |
| | | (serpentine) | | | | | | |
| Example 13 | 55 | 30 | 7.5 | 7.5 | 800 | 586 | 2.7 | 453 |
| | | (chlorite) | | | | | | |
| Example 14 | 50 + 4 | 15 + 6 | 7.5 + 5 | 12.5 | 800 | 515 | 4.3 | 219 |

Comparative Examples 1 and 2 demonstrate that it is impossible to produce a construction material made only from aluminum hydroxide. In Comparative Example 3 (Patent Literature 1), the use of fixing of clay provides a moisture control construction material having a bending strength of about 2.3 MPa, in which the moisture control performance is 657 g/m². However, the processability is as low as 100 mm/30 seconds.

In each of Examples 1 to 11, the processability is superior to Comparative Example 1. In each of Examples 1 and 2 in which a large amount of talc is incorporated, the processability is extremely high. Also in Example 3 in which talc is used in combination with clay and in which the talc content is higher than the clay content, the moisture control properties and processability are excellent.

In Example 4, the composition has a reduced aluminum hydroxide content and an increased talc content, compared with Example 3. Example 4 is excellent in the moisture control properties and the processability. However, the reduction in aluminum hydroxide content reduces the processability. This demonstrates that the entanglement of talc with aluminum hydroxide improves the processability.

In Examples 1 and 2, the same composition is used. In the case of Example 2 in which the firing temperature is 850° C., which is 50° C. higher than that in Example 1, although the strength is higher than that in Example 1, the moisture control properties are reduced. This is presumably because the raw material has a two-component system containing aluminum hydroxide and talc and thus sintering proceeds by the temperature increase by 50° C.

With respect to Examples 5 and 6, the raw materials each have a three-component system containing aluminum hydroxide, talc, and clay and have the same composition. In Example 6 in which the firing temperature is 850° C., the moisture control performance is higher than that in Example 1. Furthermore, in Example 6, the bending strength is higher than those in Examples 1 and 2.

In Example 7 in which three components, i.e., aluminum hydroxide, talc, and bentonite, are incorporated and in each of Examples 8 and 9 in which four components, i.e., aluminum hydroxide, talc, clay, and bentonite, are incorporated, the moisture control properties and the bending strength are high. The processability is lower than those in Examples 1 to 3 but is sufficiently higher than that in Comparative Example 3.

In each of Examples 10 and 11, four components, i.e., aluminum hydroxide, talc, clay, and bentonite, are incorporated, and the aluminum hydroxide content is reduced. In the case of each of Examples 10 and 11, the moisture control properties are low, corresponding to the low aluminum hydroxide content. However, the bending strength is high. This demonstrated that in order to achieve high moisture control properties, the aluminum hydroxide content is preferably set to about 25% by weight or more.

As is clear from the foregoing examples and comparative examples, according to the present invention, the moisture control construction material having excellent moisture control properties, strength, and processability is provided.

While the present invention has been described in detail using the specific embodiments, it will be obvious to those skilled in the art that various changes may be made without departing from the spirit and the scope of the invention.

This application is based on Japanese Patent Application No. 2011-51521 filed Mar. 9, 2011, which is hereby incorporated by reference herein in its entirety.

1. A moisture control construction material produced by forming a raw material that contains aluminum hydroxide, a talc-like material, clay, and bentonite and/or montmorillonite, and firing the formed raw material.

2. The moisture control construction material according to claim 1, wherein the raw material contains 20% to 80% by weight aluminum hydroxide, 5% to 70% by weight of the talc-like material, 5% to 74% by weight clay, and 1% to 30% by weight bentonite and/or montmorillonite.

3. A moisture control construction material produced by forming a raw material that contains aluminum hydroxide and a talc-like material, and firing the formed raw material.

4. The moisture control construction material according to claim 3, wherein the raw material contains 20% to 95% by weight aluminum hydroxide and 5% to 80% by weight of the talc-like material.

5. The moisture control construction material according to claim 3, wherein the raw material contains 20% to 90% by weight aluminum hydroxide, 5% to 70% by weight of the talc-like material, and 5% to 75% by weight clay.

6. The moisture control construction material according to claim 3, wherein the raw material contains 20% to 90% by weight aluminum hydroxide, 5% to 70% by weight of the talc-like material, and 3% to 30% by weight bentonite and/or montmorillonite.

7. The moisture control construction material according to claim 1, wherein the talc-like material is at least one of talc, a serpentine subgroup, and a chlorite group.

8. The moisture control construction material according to claim 3, wherein the talc-like material is at least one of talc, a serpentine subgroup, and a chlorite group.

9. A method for producing a moisture control construction material comprising forming a raw material that contains aluminum hydroxide, a talc-like material, clay, and bentonite and/or montmorillonite; and firing the formed raw material at 700° C. to 1100° C.

10. The method for producing a moisture control construction material according to claim 9, wherein the raw material contains 20% to 80% by weight aluminum hydroxide, 5% to 70% by weight of the talc-like material, 5% to 74% by weight clay, and 1% to 30% by weight bentonite and/or montmorillonite.

11. A method for producing a moisture control construction material comprising forming a raw material that contains aluminum hydroxide and a talc-like material; and firing the formed raw material at 700° C. to 1100° C.

12. The method for producing a moisture control construction material according to claim 11, wherein the raw material contains 20% to 95% by weight aluminum hydroxide and 5% to 80% by weight of the talc-like material.

13. The method for producing a moisture control construction material according to claim 11, wherein the raw material contains 20% to 90% by weight aluminum hydroxide, 5% to 70% by weight of the talc-like material, and 5% to 75% by weight clay.

14. The method for producing a moisture control construction material according to claim 11, wherein the raw material contains 20% to 90% by weight aluminum hydroxide, 5% to 70% by weight of the talc-like material, and 3% to 30% by weight bentonite and/or montmorillonite.

15. The method for producing a moisture control construction material according to claim 11, wherein the talc-like material is at least one of talc, a serpentine subgroup, and a chlorite group.

16. The method for producing a moisture control construction material according to claim 11, wherein at least part of the raw material is calcined.
